(19) United States
(12) Patent Application Publication
(10) Pub. No.: US 2008/0240999 A1
(43) Pub. Date: Oct. 2, 2008

(54) PIPETTE TIP TRANSFER SYSTEM

(76) Inventors: Alma Adelbert Timpson, Heber, UT (US); Alma Leroy Jessop, West Jordan, UT (US); Brigham Smith Timpson, West Jordan, UT (US)

Correspondence Address: HOLME ROBERTS & OWEN, LLP, 299 SOUTH MAIN, SUITE 1800, SALT LAKE CITY, UT, 84111, US

(21) Appl. No.: 11/693,602

(22) Filed: Mar. 29, 2007

(51) Int. Cl. B01L 3/02

(52) U.S. Cl. 422/100

(57) ABSTRACT

A pipette tip transfer and storage system includes a transfer tray configured to receive and store a plurality of pipette tips. The transfer tray includes a means of grasping the tray so that it may be inserted and removed from a storage container. The storage container includes a lower base unit for receiving and storing the transfer tray and an upper lid unit configured to securely cover the base unit. The storage container includes ridges configured to register with and engage ridges on the transfer tray to effect a secure fit between the storage container and the transfer tray. The lid unit includes ridges along an upper surface configured to register with the lower surface of a base unit, allowing a plurality of storage containers to be stored in a stacked configuration.

### BACKGROUND OF THE INVENTION

1. The Field of the Invention

The present invention relates generally to a packaging and transfer system for disposable pipette tips. In particular, the present invention relates to an improved packaging and transfer system for pipette tips useful in connection with multiple bases.

2. State of the Art

Medical and research laboratories are called upon to perform large numbers of repetitive tests. For example, large quantities of routine blood test may be performed by a laboratory technician at one time. Samples of the blood in test tubes may be arranged in an array to facilitate speed in performance of the tests. For example, the test tubes may be arranged on a rack eight tubes wide by twelve tubes deep. Specific chemical or biological materials are then added to each tube in like amounts as part of the testing process. The chemical or biological materials are added by first associating a pipette tip to a pipette tool, and then operating that tool to draw in and subsequently eject the chemical or biological material through the pipette tip into, for example, selected test tubes.

For testing of arrays of test tubes, multi-site pipette tools are provided that can hold multiple pipette tips. Pipette tips are provided on trays or racks in an array so that a multi-site pipette tool may easily register with each site of the multi-site pipette tool. The pipette tips are typically ejected from the pipette tool by operation of the tool and in the process typically placed in a suitable receptacle for destruction.

The pipette tips are typically supplied in trays which have openings for receiving 96 pipette tips. Typically, each of these trays is packaged in an outer box and both the box and the tray are discarded once the tips have been used. For laboratory facilities performing many hundreds of tests every day, the pipette tips, their associated trays and their boxes result in large amounts of waste.

Methods and systems have been developed that allow the trays to be reloaded with pipette tips once the trays are empty to reduce the need to dispose of boxes and trays. However, the systems and the methods typically require some amount of practice and even skill effect alignment of a pipette tips for positioning in a suitable base.

Thus, the laboratories and other testing facilities have a need for an inexpensive pipette tip packaging, storage, and transfer system that permits storage of pipette tips within a container of compact size in order to reduce the storage space needed to stock the pipette tips and to further reduce the amount of packaging material used and thrown away. Furthermore, a need exists for a pipette tip storage and transfer system that is simple and easy to use to facilitate transfer of pipette tips from a storage container to a holding tray without requiring latching mechanisms or other moving parts.

### BRIEF SUMMARY OF THE INVENTION

Embodiments of the invention include a pipette tip transfer system configured to support and store a number of pipette tips. The system includes a transfer member having a plurality of apertures configured to receive, support, and store pipette tips. The transfer system further includes features that aid in reloading the transfer member with pipette tips after all of the pipette tips initially loaded in the transfer member are used. For example, the transfer member includes locking projections on an upper surface of the transfer member that register with alignment holes on a reloading plate used to reload an empty transfer member with new pipettes. The locking projections engage the alignment holes of the reloading plate in a manner that substantially secures the reloading plate to the transfer member. Other features include grooves in the upper surface of the transfer member that are configured to aid in applying a force to a reloading plate secured to the transfer member in order to effect the removal of the reloading plate from the transfer member. Raised gripping elements positioned on opposite sides of the transfer member allow the transfer member to be grasped and manipulated, such as for inserting the transfer member into a storage container. Ridges on the sides of the transfer member are configured to register with locking ridges located within the storage container. A transfer member with pipette tips is configured such that an additional transfer member with pipette tips may be stacked upon it, the pipette tips of the overlying transfer member nesting within the pipette tips of the lower transfer member.

The transfer system also includes a storage container with a base configured to receive, support, and retain the transfer member with the pipette tips. Vertical members within the base of the storage container support the transfer member while locking ridges positioned within the storage container register with ridges on the transfer member to retain the transfer member within the storage container. The storage container includes a lid that covers the storage container and is configured to enclose the retained transfer member with the storage container. The lid is configured to receive a base of an additional storage container that is stacked upon the lid. Ridges positioned around the perimeter of the lid substantially limits movement of the upper storage container in lateral directions.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a side view of a long axis of a transfer member and a pipette tip stored therein;

FIG. 2 illustrates a top view of an upper surface of the transfer member;

FIG. 3 illustrates a side view of the transfer member;

FIG. 4 illustrates a side view of a locking projection of the transfer member;

FIG. 5 illustrates a top view of a reloading plate secured to a transfer member;

FIG. 6 illustrates a cross-section A-A of a reloading plate secured to a transfer member;

FIG. 7 illustrates a top view of a base unit of a storage container;

FIG. 8 illustrates a top view of a hinge assembly of the base unit of the storage container;

FIG. 9 illustrates a cross-section B-B of the base of the storage container illustrated in FIG. 7;

FIG. 10 illustrates a front view of a base of a storage container;

FIG. 11 illustrates a cross-section C-C of the base of the storage container illustrated in FIG. 7;

FIG. 12 illustrates a side view of the base of the storage container;

FIG. 13 illustrates a top view of a lid of the storage container;

FIG. 14 illustrates a front view of the lid of the storage container;

FIG. 15 illustrates a side view of the lid of the storage container;

FIG. 16 illustrates a side view of the base of the storage container with a transfer member stored therein;

FIG. 17 illustrates a side view of the storage container with a transfer member and a pipette tip stored therein;

FIG. 18 illustrates a front view of the storage container with a transfer member and a plurality pipette tips stored therein;

FIG. 19 illustrates a top view of the storage container with a transfer member stored therein;

FIG. 20 illustrates a front view of a plurality of storage containers in a stacked arrangement with a transfer member and a plurality pipette tips stored within each of the plurality of storage containers, and

FIG. 21 illustrates a shipping container including a plurality of transfer members storing a plurality of pipette tips.

### DETAILED DESCRIPTION OF THE PREFERRED EMBODIMENTS

Reference will now be made in detail to embodiments of the present invention, examples of which are illustrated in the accompanying drawings. The various embodiments provide a pipette tip storage and transfer system. It is to be understood that the drawings are diagrammatic and schematic representations of such exemplary embodiments, and are not limiting of the present invention, nor are they necessarily drawn to scale.

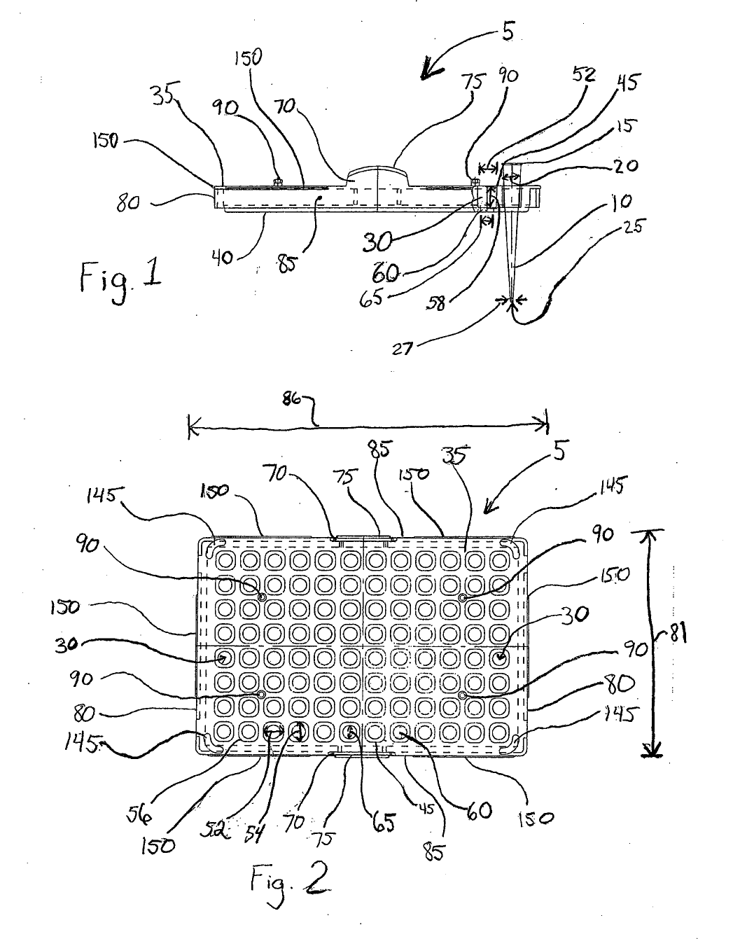

A transfer tray, or member, 5 is illustrated in a form of a tray in FIGS. 1 through 3. The transfer tray 5 is formed from various kinds of plastic, preferably of the type that can be placed in an autoclave, nylon, and other like materials that have sufficient rigidity or strength, as well as being lightweight and susceptible to sterilization in an autoclave. Most are formed using suitable molding processes. The transfer tray has an upper surface 35, a lower surface 40, and side surfaces 80, 85. It should be noted, that while sides 80, 85 provide a transfer member with a substantially rectangular shape with a width 81 and a length 86, respectively, as best seen in FIG. 2, the dimensions of sides 80, 85 can be selected so that a given transfer member 5 will fit in storage containers of different sizes and shapes, as will be described in further detail below.

The transfer tray 5 is configured to receive and store a plurality of pipette tips, such as pipette tip 10, for storage and transfer. The pipette tip 10 has a first end 15 with a first outer diameter 20 and a second end 25 that has an outer diameter 27 smaller than the outer diameter 20 of the first end 15.

The transfer tray 5 receives a pipette tip 10 in an aperture 30 that passes from the upper surface 35 of the transfer tray 5 through to the lower surface 40 of the transfer tray 5. The aperture 30 has an upper opening 45 in the upper surface 35 of the transfer tray 5 that is configured to receive a pipette tip 10. The upper opening 45 in this example, as better seen in FIG. 2, is substantially square shaped with a rounded fillet 56. The fillet 56 provides a measure of stress reduction around the upper opening 45 and aids in reducing the likelihood of cracking and fracturing around the upper opening 45. The upper opening 45 has a length 52 and width 54 that are greater than the outer diameter of the second end 25 of the pipette tip 10. In the illustration, the length 52 and width 54 are less than the diameter 20 of the first end 15 of the pipette tip 10, although other lengths 52 and widths 54 that are substantially the same as or greater than the diameter 20 of the first end 15 of the pipette tip 10 fall are embodied within the scope of the invention. Furthermore, while the upper opening 45 is illustrated to be substantially square in the drawings, the upper opening 45 includes embodiments that circular, oval, and other shapes that are selected and configured to receive a pipette tip 10. The wider, substantially square shape of the upper opening 45 allows for a pipette tip 10 or a plurality of pipette tips 10 to be received in the aperture 30 more easily.

Returning to the example illustrated in FIGS. 1 and 2, the length 52 and width 54 are substantially maintained through a height 58 as the aperture 30 passes from the upper surface 35 towards the lower surface 40 of the transfer tray 5. The aperture 30 exits through a lower opening 60 in the lower surface 40 of the transfer tray 5. The lower opening 60 has a diameter 65 that is greater than the outer diameter 27 of the second end 25 of the pipette tip 10 but is less than the diameter 20 of the first end 15 of the pipette tip 10. In this instance, the lower opening 60 is substantially the shape of a circle, although it will be appreciated that the lower opening 60 can be of other shapes, such as oval, substantially square and the like.

Thus, it will be appreciated that the dimensions 52, 54, and 65 of the aperture 30 are selected and configured to receive a pipette tip 10. For example, a transfer tray 5 with a plurality of apertures 30 having relatively smaller length 52, width 54, and diameter 65 would be used with a smaller diameter pipette tip 10, while another transfer tray 5 with a plurality of apertures 30 having relatively larger dimensions 52, 54, 65 would be used with a larger diameter pipette tip 10. Additionally, while FIGS. 1 and 2 illustrate an aperture 30 having an upper opening 45 that is substantially square and a lower opening 60 that is substantially circular with a discrete change in dimension from a relatively larger length 52 and width 54 to a relatively smaller diameter 65, respectively, it will be appreciated that the aperture 30 can be configured in other ways. For example, the aperture 30 may be conical in shape with a continuous change in length 52 and width 54 to diameter 65 over the height 58 rather than having a substantially constant length 52 and width 54 over the height 58 with a discrete change to diameter 65 at the lower opening 60.

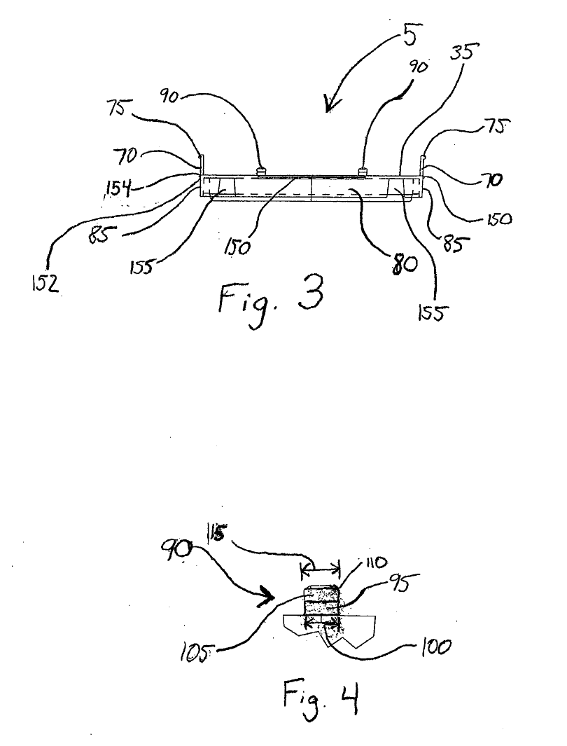

The plurality of apertures 30 are seen in an 8×12 array in FIG. 3, resulting in ninety-six (96) apertures 30 that are capable of receiving ninety-six pipette tips 10. While the apertures 30 are in this 8×12 pattern, the number of apertures 30 may be lesser or greater according the user's needs and the size (e.g., diameter) of the pipette tips 10 to be received in the apertures 30. For example, for pipette tips 10 of a relatively larger diameter a smaller pattern or array of apertures 30 is used because fewer apertures 30 with an upper opening 45 having a given length 52 and width 54 can fit in a transfer plate 5 having side surfaces 80, 85 of a given width 81 and length 86. Further, other patterns than a column and row configuration are contemplated, such as a staggered pattern that maximizes the density of apertures 30 in an upper surface 35.

The transfer tray 5 includes a plurality of gripping elements 70 that are configured to allow a user to insert and remove the transfer tray 5 from a storage container or a shipping container as will be described in further detail below. In this example, each of the gripping elements 70 are on opposing side surfaces 85 of the transfer tray 5 proximate the upper surface 35, which, in this instance, are the longest side surface of the transfer tray 5. It will be understood, though, that the gripping elements 70 can be placed on opposing side surfaces 80, which are relatively shorter than the longer side surfaces 85. Furthermore, while only two gripping elements 70 are illustrated in FIGS. 1 through 3, additional side elements may be used. For example, gripping elements 70 can be placed on each of the sides 80, 85, resulting in four gripping elements 70 positioned on the transfer tray 5. Other configurations are also contemplated and fall within the scope of the embodiments.

The gripping elements 70 include a ridge 75 configured to permit a user to more easily grip the gripping element 70. The ridge can be an additional element added to the gripping element 70, or it can be formed integrally with the gripping element 70.

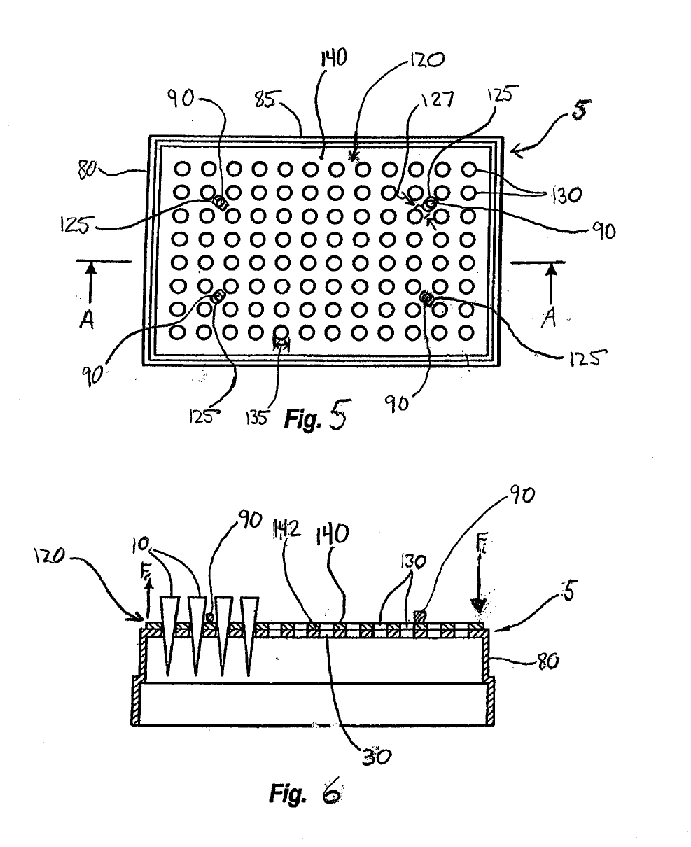

Embodiments of the invention include a locking projection 90 or a plurality of locking projections 90 on the upper surface 35 of the transfer tray 5 that are configured to insert into and engage alignment slots 125 on a reloading, or receiving, tray 120 seen in FIGS. 5 and 6, such as those described in U.S. Pat. No. 7,060,226 to Jessop et al., whose disclosure is herein incorporated in its entirety by this reference for all purposes.

Referring to FIG. 4, an embodiment of a locking projection 90 is illustrated in profile and includes a first lower segment 95 having a first diameter 100 and a second upper segment 105 having a second diameter 115. In this example, the lower segment 95 is substantially cylindrical, while the upper segment 105 is also substantially cylindrical with a fillet 110 that increases the diameter of the upper segment 105 from a first diameter 100 to a relatively larger diameter 115.

Turning to FIGS. 5 and 6, a reloading tray 120 includes a plurality of apertures 130 for receiving and storing a plurality of pipette tips 10. A diameter 135 of the apertures 130 are larger than the diameter of the second end 25 of the pipette tip 10 but smaller than the diameter 20 of the first end 15 of the pipette tip 10, allowing the reloading tray 120 to maintain the pipette tip 10 in a substantially vertical manner. The plurality of apertures 130 are configured to align with the apertures 30 on the transfer tray 5, and the alignment slots 125 substantially align with the locking projections 90 on the transfer tray 5. The alignment slots 125 have a width 127 that is substantially similar to or slightly less than the diameter 115 of the locking projection 90, which creates an interference or friction fit between the alignment slot 125 and the upper segment 105 of the locking projection 90. The width 127 of the alignment slot 125 is substantially similar to or slightly greater than the diameter 100 of the lower segment 95 of the locking projection 90. It will be appreciated that the size, shape, and location of the locking projections 90 and the alignment slots 125 can be modified to suit the particular transfer tray 5 and reloading plate 120, the pattern of apertures 30 and 130, and other considerations as necessary.

In practice, the reloading plate 120 is installed onto the upper surface 35 of the transfer tray 5 by aligning the apertures 130 of the reloading plate 120 and any pipette tips 10 therein with the apertures 30 on the transfer tray 5, as well as aligning the alignment slots 125 or the reloading tray 120 with the locking projections 90 of the transfer tray 5. Once so aligned, a force Fᵢ in a substantially downward vertical direction is applied to the upper surface 140 of the reloading tray 120, in a corner of the upper surface 140, for example. Because the diameter 115 of the upper segment 105 of the locking projection 90 is substantially similar to or slightly greater than the width 127 of the alignment slot 125, the force Fᵢ overcomes the frictional force resisting the installation of the reloading tray 120 on the upper surface 35 of the transfer tray 5. The alignment slot 125 elastically deforms slightly as it passes over the fillet 110 of the locking projection 90, the fillet 110 acting to marginally decrease the force Fᵢ necessary to install the reloading tray 120. Once the wider upper segment 105 of the locking projection passes through the alignment slot 125, the reloading plate 120 is substantially secured to the upper surface 35 of the transfer tray 5.

Turning back to FIG. 2, the upper surface 34 of the transfer tray 5 includes at least one groove 145. In this example, the grooves 145, one in each corner of the upper surface 35 of the transfer tray 5, are of arcuate shape and are configured to aid in removing the reloading plate 120 from the upper surface 35 of the transfer tray 5. The arcuate grooves 145 allow a force Fᵣ to be applied in a substantially upward vertical direction with a finger nail, for example, to a lower surface 142 of the reloading plate 120, as best seen in FIG. 6. In applying the force Fᵣ to the lower surface 142 of the reloading plate 120, the reloading plate 120 is raised away from the upper surface 35 of the transfer tray 5. In turn, the alignment slot 125 of the reloading plate 120 moves up the lower segment 95 of the locking projection 90 and encounters the fillet 110 and the relatively wider diameter 115 of the upper segment 105 of the locking projection 90. The force Fᵣ overcomes the friction force between the alignment slot 125 and the upper segment 105 of the locking projection 90 that is resisting the removal of the reloading plate 120 from the upper surface 35 of the transfer tray 5. It will be appreciated that the grooves 145 can be of different shapes and sizes to accommodate different transfer trays 5 and reloading plates 120, as well as being positioned in different locations on the upper surface 35 of the transfer tray 5 rather than in the corners as illustrated in FIG. 2.

The transfer tray 5 also includes a plurality of engagement ridges 150 positioned proximate the upper surface 35 on the sides 80, 85 and configured to engage with retaining ridges 250 positioned in a storage container 160 as will be described in greater detail below. As seen in FIG. 2, two engagement ridges 150 are positioned on each of the sides 85 and one engagement ridge 150 is positioned on each side 80. Other configurations of engagement ridges 150 are contemplated, such as including engagement ridges 150 on only one pair of sides 80 and 85, using more or fewer engagement ridges 150 on a given side, positioning the engagement ridges 150 at different locations on the sides 80, 85, and the like. Optionally, each of the engagement ridges 150 includes a slanted upper surface 154 and a slanted lower surface 152, as best illustrated in FIG. 2, that are configured to reduce the amount of force necessary to remove and install the transfer tray 5 from the base unit 165 of the storage container 160, as will be described in greater detail below.

Finally, the transfer tray 5 optionally includes at least one or more slots 155 positioned near a periphery of the sides 80. The slots 155 are configured to register with support elements of a storage container as will be described in further detail below. It will be appreciated that the position, size, and shape of the slots are selected to interact with the support elements as desired, including positioning the slots 155 on the sides 85, increasing or decreasing the number of slots 155, and the like.

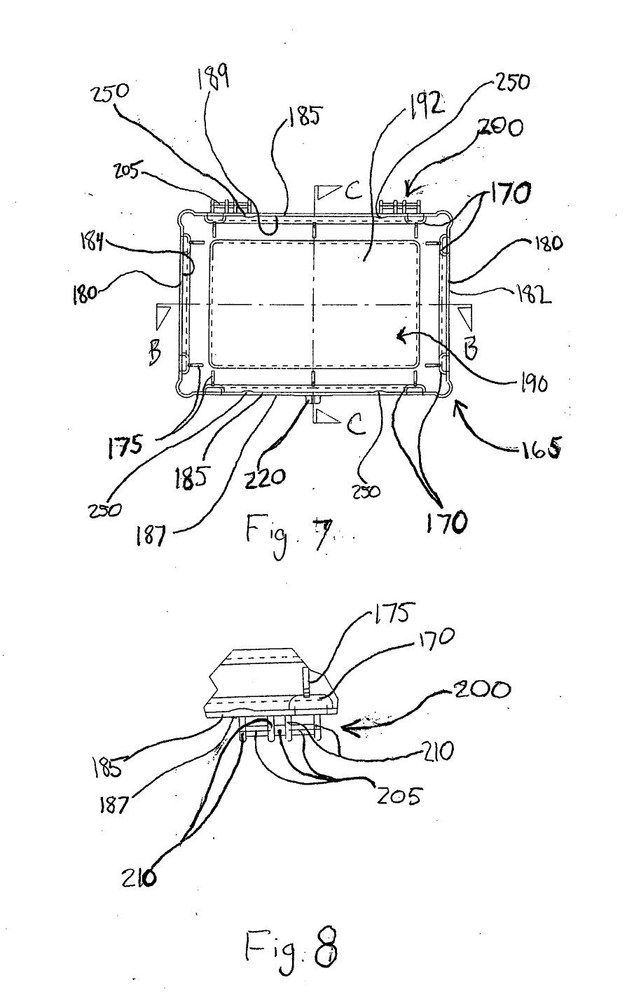

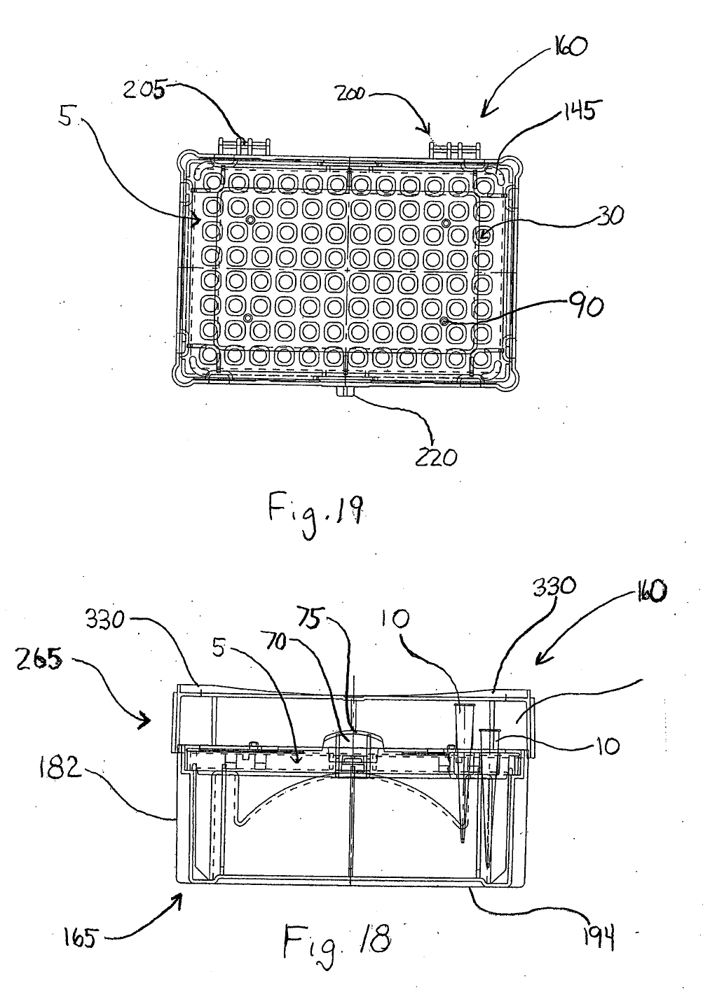

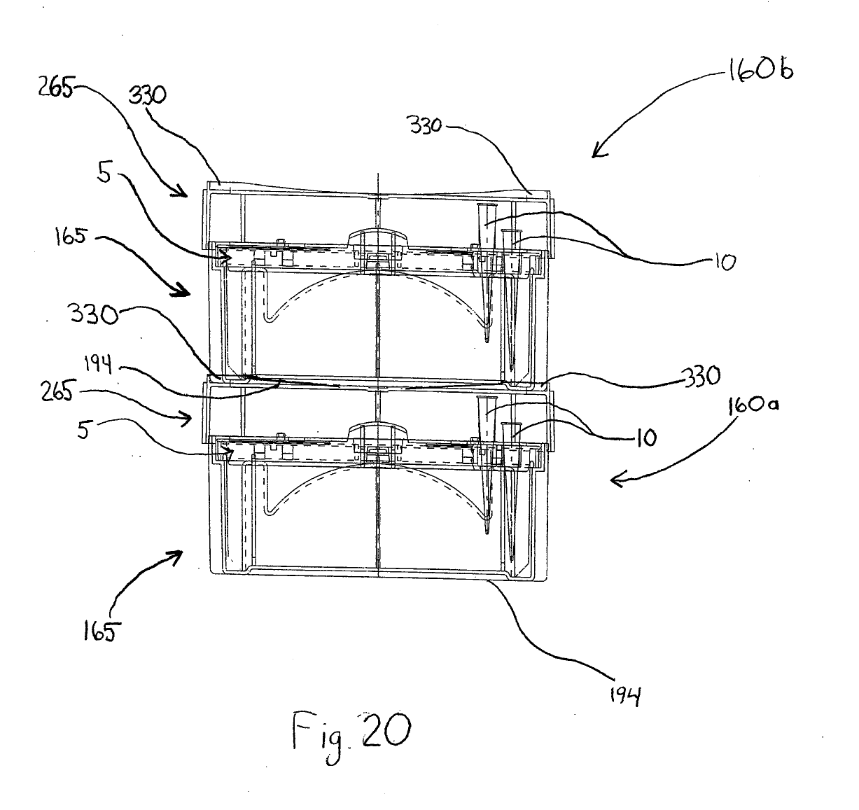

Embodiments of the invention also include a storage container 160 as illustrated in FIGS. 7-19. A base unit 165 of the storage container 160 is illustrated in top view in FIG. 7. The base unit 165 includes a plurality of sides 180, 185. In this example, the length 181, 186 of the sides 180, 185, respectively, are such that the base unit 165 is rectangular in shape, but other lengths and shapes of sides 180, 185 are contemplated and fall within the various embodiments of the invention. The sides 180 include an outer side surface 182 and an inner side surface 184, while the sides 185 include an outer side surface 187 and an inner side surface 189. The base unit 165 also includes a bottom 190 that is adjacent to and connected with the side surfaces 180, 185, the bottom including an inner bottom surface 192 and an outer bottom surface 194. The bottom 190 and sides 180, 185 together form a box configured to store the transfer tray 5 as will be described in further detail below. The base unit 165, including the sides 180, 185 and bottom 190, can be formed with various kinds of plastic, preferably of the type that can be placed in an autoclave, nylon, and other like materials that have sufficient rigidity or strength, as well as being lightweight and susceptible to sterilization in an autoclave. Most are formed using suitable molding processes.

Support elements 170 are positioned on the inner side surface 184, 189 of the sides 180, 185 respectively and are configured to support the sides 80, 85 and the lower surface 40 of the transfer tray 5. In addition, the support elements 170 add a measure of structural rigidity to the sides 180, 185. The support elements 170 can be an additional feature added to the sides 180, 185. Optionally, and as illustrated in the drawings, the support elements 170 are formed as an integral structural component of the sides 180, 185 during the molding process.

Optionally formed on the periphery of the support elements 170 are stiffeners 175 that connect to the inner bottom surface 192. The stiffeners provide a further measure of structural rigidity to the sides 180, 185 and to the inner bottom surface 192.

A plurality of retaining ridges 250 are positioned proximate to an upper edge 188 of the inner side surfaces 189 of the sides 185. The retaining ridges are configured to register with and engage the engagement ridges 150 of the transfer tray 5 when the transfer tray is inserted into, stored, and removed from the base unit 165. The retaining ridges 250 are an arcuate shape and formed integrally with the side 185 and each retaining ridge 250 includes a slanted surface 252 on the under side of the retaining ridge 250 configured to reduce the amount of force necessary to remove the transfer tray 5 from the base unit 165 as will be described in further detail below.

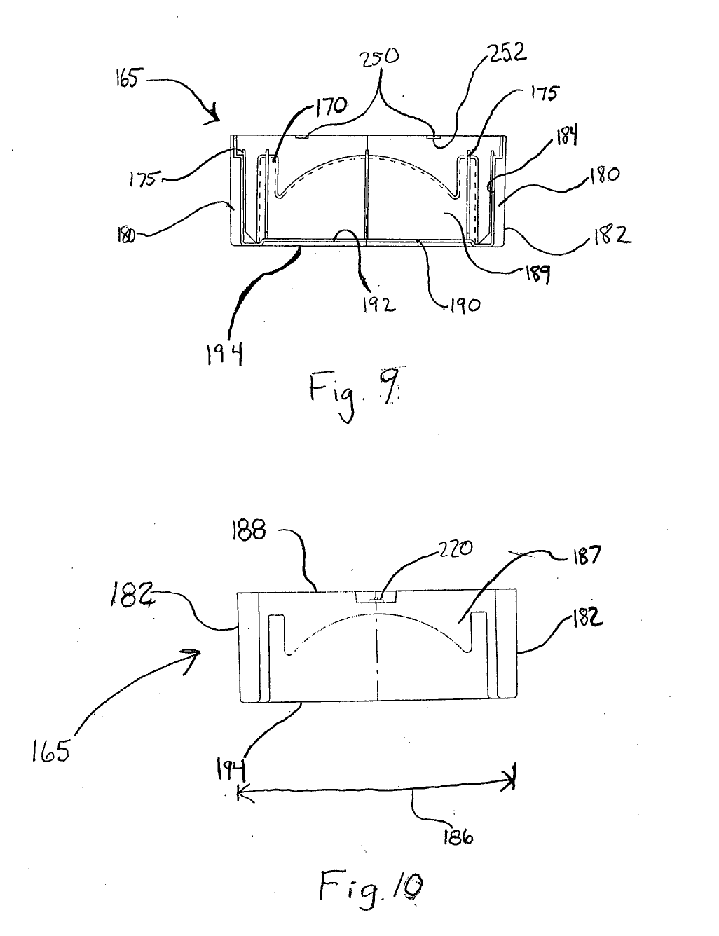

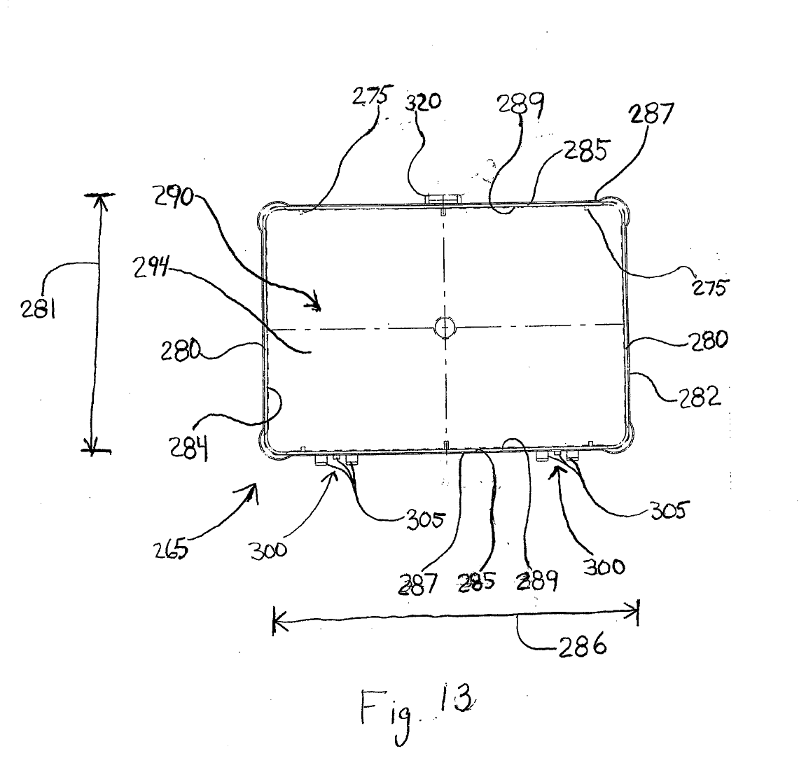

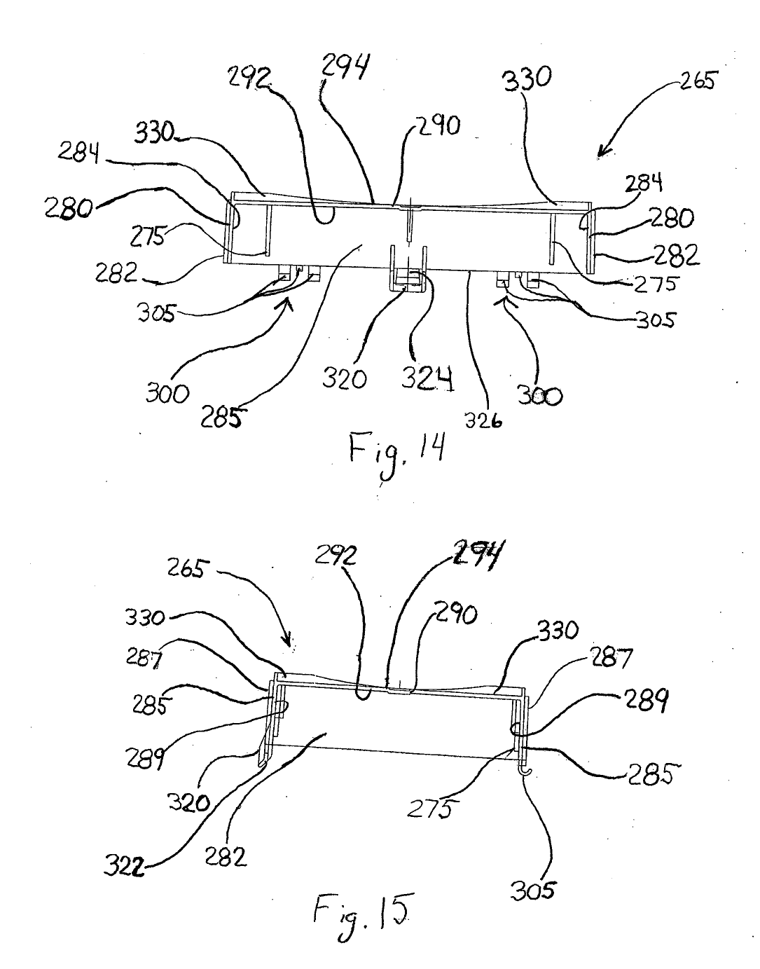

A hinge pivot assembly 200, seen in detail in FIG. 8, is positioned proximate the upper edge 188 of the outer side surface 187 of the side 185, although in other configurations the hinge pivot assembly 200 is positioned proximate the upper periphery of the outer side surface 182 of the side 180. The hinge pivot assembly 200 includes a pivot bar 205 that is gripped by a hook assembly 300 on a lid unit 265 (illustrated in FIGS. 13 through 15) and around which the lid unit 265 pivots. Bearing members 210 join the pivot bar 205 to the upper periphery of the outer side surface 187 of the side 185. The hinge pivot assembly 200 is formed as an integral part of the side 185 in the illustration, although other embodiments include a hinge pivot assembly 200 that is affixed and joined to the side 185. The hinge pivot assembly 200 further is configured and sized to support the lid unit 265 and the associated forces that occur when the lid unit 265 is raised, lowered, or otherwise pivoted about the axis of the pivot bar 205.

The base unit 165 also includes a hook, or ledge, 220 proximate the upper edge 188 of outer side surface 187 of side 185, although in other configurations the hook 220 is positioned proximate the upper periphery of the outer side surface 182 of the side 180. The hook 220 is configured and sized to be engaged by the latch assembly 320 on the lid unit 265 (illustrated in FIGS. 13 through 15) to effect a substantially secure closure of the lid unit 265 against the base unit 165. The hook 220 is formed as an integral part of the side 180 in the illustration, although other embodiments include a hook 220 that is affixed and joined to the side 180.

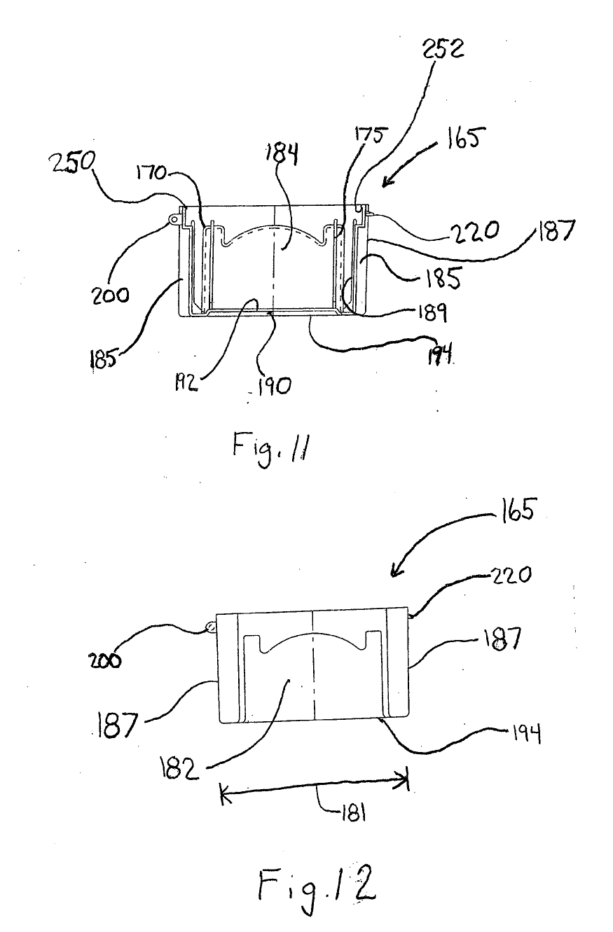

Cross-section B-B illustrates an interior view of the base unit 165 and is seen in FIG. 9 and FIG. 10 illustrates a view of the base unit 165 from the front.

Cross-section C-C illustrates an interior view of the base unit 165 and is seen in FIG. 11 and FIG. 12 illustrates a view of the base unit 165 from the side.

The lid unit 265 of the storage container 160 is illustrated in FIGS. 13 through 15. The lid unit 265, seen in a top view in FIG. 13, includes a plurality of side surfaces 280, 285. In this example, the length 281 and length 286 of the sides 280, 285, respectively, are such that the lid unit 265 is rectangular in shape, but other lengths 281, 286 and shapes of sides 280, 285 are contemplated and fall within the various embodiments of the invention. Additionally, the lengths 281, 286 of the sides 280, 285 are relatively larger than the corresponding lengths 181, 186 of the sides 180, 185, respectively, of the base unit 165. The sides 280 include an outer side surface 282 and an inner side surface 284, while the sides 285 include an outer side surface 287 and an inner side surface 289. The lid unit 265 also includes a top 290 that is adjacent to and connected with the side surfaces 280, 285, the top including an inner top surface 292 and an outer top surface 294. The lid unit 265, including the sides 280, 285 and top 290 can be formed with various kinds of plastic, preferably of the type that can be placed in an autoclave, nylon, and other like materials that have sufficient rigidity or strength, as well as being lightweight and susceptible to sterilization in an autoclave. Most are formed using suitable molding processes. Optionally, the lid unit 265 is formed in various embodiments with a transparent or substantially transparent plastic to allow a user to see inside the lid unit 265 into the base unit 165 of the storage container 160 to determine what contents, such as the size and number of pipette tips 10, are stored within.

The lid unit 265 also includes one or more stiffeners 275, in this example the stiffeners are vertical members positioned on the inner top surface 289 to provide a measure of rigidity to the lid unit 265, although the stiffeners can be horizontal or positioned at an angle. The stiffeners 275 are formed integrally with the side 285, although in other embodiments the stiffeners are affixed and joined to the side 285.

In addition, the lid unit 265 includes a hook assembly 300 positioned proximate a lower edge 326 of a first side 285 and configured to engage the pivot bar 205 of the hinge pivot assembly 200 on the base unit 165. The hook assembly 300 includes at least one hook 305 configured to register with and engage the pivot bar 205 of the hinge pivot assembly 200 and allows the lid unit 265 to pivot about the axis of the pivot bar 205 and effect an opening and closing of the lid unit 265.

The lid unit 265 also includes a latch assembly 320 positioned proximate a lower edge 326 of a second side 285 opposite the first side 285 and configured to register with and engage a hook 220 of the base unit 165 in order to effect a closure of the lid unit 265 to the base unit 165. The latch assembly 320 is positioned proximate to the center line and the lower periphery of the outer side surface 287 of the side 285, although it will be appreciated that the latch assembly 320 can be positioned on the outer side surface 284 if the hook 220 is so configured on the side surface 184 of the base unit 165. In addition, while a single hook 220 and latch assembly 320 are depicted, a plurality of hooks 220 and latch assemblies 320 can be utilized in other embodiments of the invention. As seen in FIG. 15, a slanted surface 322 of the latch assembly 320 is configured to slide along the hook 220 and thereby reduce the force necessary to effect engagement of the latch assembly 320 with the hook 220 than would otherwise be necessary. The hook 220 registers with and engages a hole 324 in the latch assembly 320, thereby effecting a substantially secure closure of the lid unit 265 to the base unit 165. In other configurations, a recess, a depression, and other similar configurations that registers with and engages a hook 220 are utilized instead of a hole 324. The latch assembly 320 is formed integrally with the lid unit 265, although other embodiments include a latch assembly 320 affixed to the lid unit 265. During the opening and closing process of the lid unit 265, the latch assembly 320, the hook 220 and the outer side surface 187 to which the hook 220 is joined, or both resiliently deform as the latch assembly 320 engages the hook 220.

Optionally, the lid unit 265 includes a plurality of lid ridges 330 positioned proximate to the periphery of the outer top surface 294 of the lid unit 265. The lid ridges 330 are configured to register with the outer bottom surface 194 of the base unit 165 that has a width 181 and a length 186 that is less than a width 281 or length 286 of the lid ridge 330.

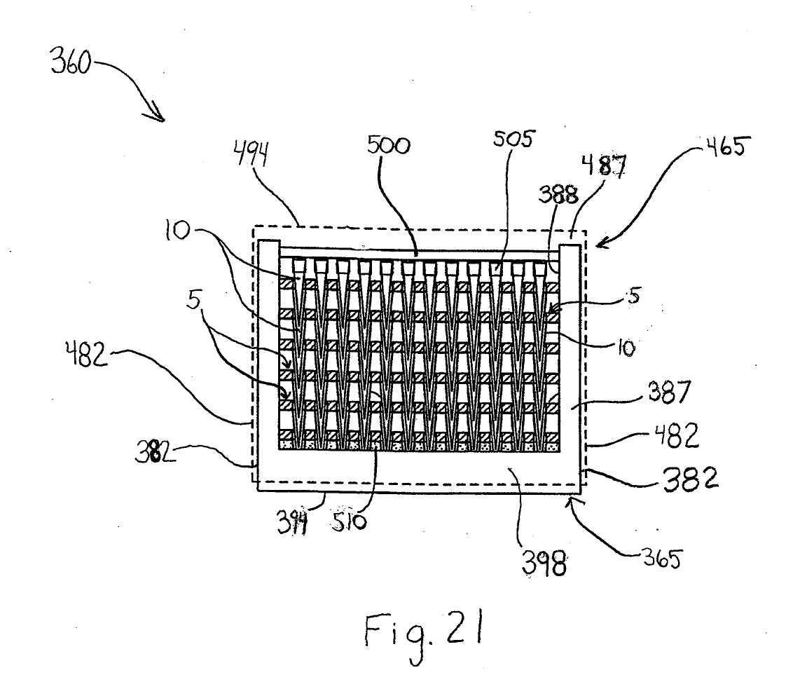

The lid ridges 330 allow a second storage container 160b to be stacked on top of a first storage container 160a, as illustrated in FIG. 20. Additional storage containers 160 can be stored atop lower storage containers 160a in a similar manner, thus reducing the footprint necessary to store a plurality of storage containers 160. In addition, the lid ridges 330 help prevent the upper storage container 160b from sliding off and falling from the lid unit 265 of the lower storage container 160a.

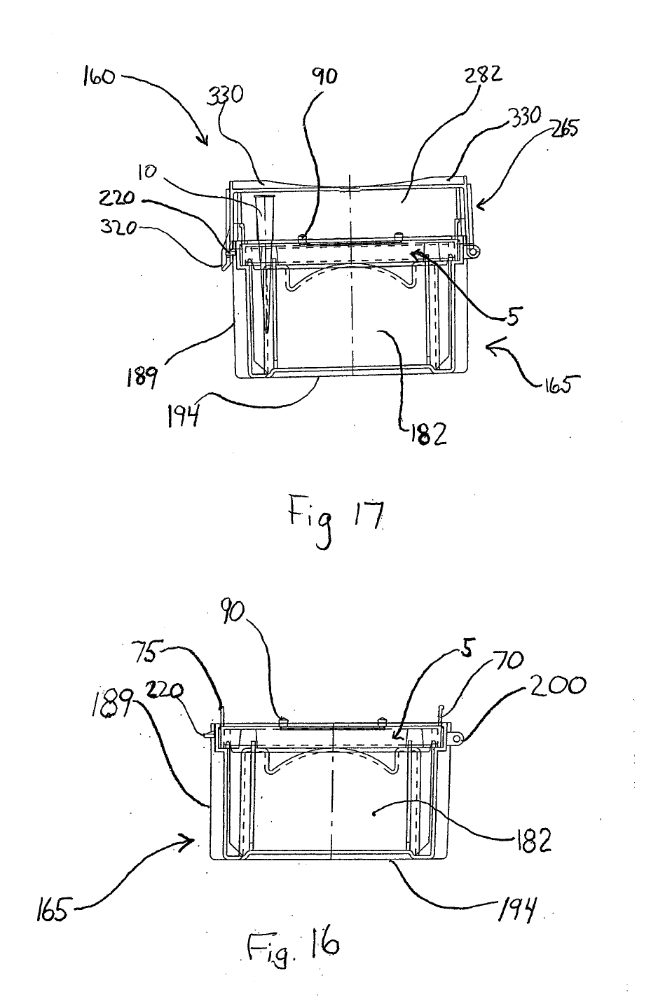

Illustrated in FIG. 16 is a transfer tray 5 is illustrated installed in the lower base unit 165 of the storage container 160.

FIGS. 17 through 19 illustrate different views of a transfer tray 5, including pipette tips 10, positioned in a storage container 160.

A packaging container 360 for shipping a plurality of transfer trays 5 is illustrated in FIG. 21. The packaging container is sized and shaped to snugly fit the plurality of transfer trays 5 that are slidably inserted into a lower packaging unit 365. The second end 25 of the pipette tips 10 of a transfer tray 5 are inserted into the first end 15 of the pipette tips 10 stored in a lower transfer tray 5 in a nested arrangement, allowing a plurality of the transfer trays 5 to be received in a stacked arrangement in the packaging container 365. The lower packing unit includes a bottom packaging surface 394 and a plurality of side packaging surfaces 382 and 387 that form a box shape. A cut-out portion 388 in side surfaces 387 allows each transfer tray 5 to be grasped and slidably inserted or removed from the lower packaging unit 365. It will be appreciated that the cut out portion 388 can be positioned in the side surface 382 as desired. A support member 510 extends inside and along a lower portion 398 of the lower packaging unit 365, raising the lower most transfer tray 5 from the bottom a sufficient distance so that the pipette tips 10 in the lower most transfer member 5 do not contact or otherwise impinge upon the lower packing unit 365. Additionally, the support member 510 raises the lower most transfer tray 5 a sufficient distance to allow the transfer tray 5 to be easily grasped through the cut out portion 388 of the side 387. A stabilizing plate 500 has a plurality of projections 505 configured in a pattern that corresponds to the pattern of apertures 30 and, hence, the first end 15 of the pipette tips 10. The projections 505 are configured to be inserted around or into the first end 15 of the pipette tip 10 in order to secure the pipette tips 10 in the upper most transfer tray 5 during shipping and thereby lessen the risk that the pipette tips 10 will fall out of the transfer tray 5 or otherwise be disturbed during shipping.

The packaging container 360 includes an upper packaging unit 465, indicated by the dashed line in FIG. 360, and includes a top surface 494 and a plurality of side surfaces 482 and 487. The upper packaging unit 465 is sized and shaped to slidably cover the lower packaging unit 365.

While a pipette tip transfer system has been described with reference to the specific embodiment described, the descriptions are only illustrative and are not to be construed as limiting the invention. As such, the optimal dimensional relationships for the parts of the exemplary embodiment of the invention can be varied in size, materials, shape, configurations, form, function and manner of operation. The optimal dimensional relationships, use and assembly that are readily apparent to those skilled in the art and all equivalent relationships to the embodiments illustrated in the drawings and described in the specification are intended to be encompassed by the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A pipette tip transfer system, comprising:
a transfer member configured to receive and store a plurality of pipette tips, the transfer member including:
a lower transfer member surface spaced apart from an upper transfer member surface;
a plurality of side transfer member surfaces positioned proximate to the upper transfer member surface;
a plurality of transfer apertures disposed in a pattern in the upper transfer member surface and extending through the lower transfer member surface, each transfer aperture configured to receive a pipette tip;
at least one engagement ridge positioned proximate the upper transfer member surface on of each of the plurality of side transfer member surfaces;
a first gripping element positioned on a first side transfer member surface proximate the upper transfer member surface and a second gripping element positioned proximate the upper transfer member surface on a second side transfer member surface, the first gripping element and second gripping element each configured to effect an insertion and a removal of the transfer member from a first storage container;
a plurality of locking projections disposed upon the upper transfer member surface;
the first storage container, the first storage container having a base unit configured to receive the transfer member therein, the base unit including:
a bottom surface having an inner bottom surface and an outer bottom surface; and
a plurality of base side surfaces, a first base side surface of the plurality of base side surfaces having a first base inner side surface and a first base outer side surface, the first base side surface positioned adjacent and substantially perpendicular to a first periphery of the bottom surface and a second base side surface of the plurality of base side surfaces having a second base inner side surface and a second base outer side surface, the second base outer side surface positioned laterally opposite the first base side surface and having the bottom surface disposed therebetween, the second base side surface positioned adjacent and substantially perpendicular to a second periphery of the bottom surface, each of the first base side surface and the second base side surface having at least one support member and at least one retaining ridge positioned proximate an upper edge of each of the first base inner side surface and the second base inner side surface, the at least one support member configured to partially support the lower transfer member surface and the at least one retaining ridge configured to register with and engage the at least one engagement ridge of the transfer member, the engagement of the at least one retaining ridge and the at least one engagement ridge operably securing the transfer member within the inner volume of the base unit.

2. The base unit of claim 1, further comprising:
a hinge assembly proximate an upper edge of the first outer side surface; and
a locking ledge positioned proximate an upper edge of the second outer side surface.

3. The storage container of claim 1, further comprising a lid unit configured to engage the base unit and operably cover and allow access to the base unit, the lid unit including:
an upper lid surface having an outer upper lid surface and an inner upper lid surface;
a plurality of lid side surfaces, a first lid side surface of the plurality of lid side surfaces having a first outer lid side surface and a first inner lid side surface, the first lid side surface positioned adjacent and substantially perpendicular to a first periphery of the inner upper lid surface and a second lid side surface of the plurality of lid side surfaces having a second lid outer side surface, the second lid side surface positioned laterally opposite the first lid side surface and having the upper lid surface disposed therebetween, the second lid side surface positioned adjacent and substantially perpendicular to a second periphery of the inner upper lid surface;
a hook assembly proximate a lower edge of the first outer lid side surface configured to register with and engage the hinge assembly of the base unit to operably effect an opening and closing of the lid unit over the base unit; and
a resilient latch assembly proximate a lower edge of the second outer lid side surface configured to register with and engage the locking ledge of the base unit to effect a secure closure of the lid unit against the base unit.

4. The pipette tip transfer system of claim 1, further comprising:
a reloading plate configured to dispose a plurality of replacement pipette tips in the plurality of transfer apertures, the reloading plate including:
a plurality of reloading apertures configured to receive a pipette tip, the plurality of reloading apertures disposed in a pattern that registers with the pattern of the plurality of transfer apertures; and
a plurality of alignment slots configured to register with and engage the locking projections on the upper transfer member surface.

5. The transfer member of claim 1, further comprising at least one groove proximate a periphery of the upper transfer member surface configured to effect removal of the reloading plate from the upper transfer member surface.

6. The transfer member of claim 5, wherein the at least one groove is arcuate in shape.

7. The transfer member of claim 1, wherein an opening of the transfer aperture is substantially square.

8. The transfer member of claim 1, wherein the first gripping element and the second gripping element each include a gripping ridge.

9. The lid unit of claim 3, further comprising a plurality of lid ridges proximate and substantially perpendicular to a periphery of the outer upper lid surface and defining an area of the upper outer lid surface configured to receive an outer bottom surface of a base unit of a second storage container, the second storage container disposed upon the first storage container in a stacked configuration.

10. The lid unit of claim 3, further comprising a plurality of a lid stability ridges disposed on each of the first inner lid side surface and the second inner lid side surface.

11. The base unit of claim 1, further comprising a plurality of base stability ridges disposed on each of the first base inner side surface and the second base inner side surface.

12. A transfer member configured to receive and store a plurality of pipette tips the transfer member comprising:
a lower transfer member surface spaced apart from an upper transfer member surface;
a plurality of side transfer member surfaces positioned proximate to the upper transfer member surface;
a plurality of transfer apertures disposed in a pattern in the upper transfer member surface and extending through the lower transfer member surface, each transfer aperture configured to receive a pipette tip;
at least one engagement ridge positioned proximate the upper transfer member surface on of each of the plurality of side transfer member surfaces;
a first gripping element positioned on a first side transfer member surface proximate the upper transfer member surface and a second gripping element positioned proximate the upper transfer member surface on a second side transfer member surface, the first gripping element and second gripping element each configured to effect an insertion and a removal of the transfer member from a storage container; and
a plurality of locking projections disposed upon the upper transfer member surface.

13. The transfer member of claim 12, further comprising:
a reloading plate configured to dispose a plurality of replacement pipette tips in the plurality of transfer apertures, the reloading plate including:
a plurality of reloading apertures configured to receive a pipette tip, the plurality of reloading apertures disposed in a pattern that registers with the pattern of the plurality of transfer apertures; and
a plurality of alignment slots configured to register with and engage the locking projections on the upper transfer member surface.

14. The transfer member of claim 12, further comprising at least one groove proximate a periphery of the upper transfer member surface configured to effect removal of the reloading plate from the upper transfer member surface.

15. The transfer member of claim 14, wherein the at least one groove is arcuate in shape.

16. The transfer member of claim 12, wherein an opening of the transfer aperture is substantially square.

17. The transfer member of claim 12, wherein the first gripping element and the second gripping element each include a gripping ridge.

18. A storage container having a base unit configured to receive the transfer member therein, the storage container comprising:
a base unit that includes:
a bottom surface having an inner bottom surface and an outer bottom surface; and
a plurality of base side surfaces, a first base side surface of the plurality of base side surfaces having a first base inner side surface and a first base outer side surface, the first base side surface positioned adjacent and substantially perpendicular to a first periphery of the bottom surface and a second base side surface of the plurality of base side surfaces having a second base inner side surface and a second base outer side surface, the second base outer side surface positioned laterally opposite the first base side surface and having the bottom surface disposed therebetween, the second base side surface positioned adjacent and substantially perpendicular to a second periphery of the bottom surface, each of the first base side surface and the second base side surface having at least one support member and at least one retaining ridge positioned proximate an upper edge of each of the first base inner side surface and the second base inner side surface, the at least one support member configured to partially support the lower transfer member surface and the at least one retaining ridge configured to register with and engage the at least one engagement ridge of the transfer member, the engagement of the at least one retaining ridge and the at least one engagement ridge operably securing the transfer member within the inner volume of the base unit;
a hinge assembly proximate an upper edge of the first outer side surface; and
a locking ledge positioned proximate an upper edge of the second outer side surface;
a lid unit configured to engage the base unit and operably cover and allow access to the base unit, including:
an upper lid surface having an outer upper lid surface and an inner upper lid surface;
a plurality of lid side surfaces, a first lid side surface of the plurality of lid side surfaces having a first outer lid side surface and a first inner lid side surface, the first lid side surface positioned adjacent and substantially perpendicular to a first periphery of the inner upper lid surface and a second lid side surface of the plurality of lid side surfaces having a second lid outer side surface, the second lid side surface positioned laterally opposite the first lid side surface and having the upper lid surface disposed therebetween, the second lid side surface positioned adjacent and substantially perpendicular to a second periphery of the inner upper lid surface;
a hook assembly proximate a lower edge of the first outer lid side surface configured to register with and engage the hinge assembly of the base unit to operably effect an opening and closing of the lid unit over the base unit; and
a resilient latch assembly proximate a lower edge of the second outer lid side surface configured to register with and engage the locking ledge of the base unit to effect a secure closure of the lid unit against the base unit; and
a plurality of lid ridges proximate and substantially perpendicular to a periphery of the outer upper lid surface and defining an area of the upper outer lid surface configured to receive an outer bottom surface of a base unit of a second storage container.

19. A pipette tip packaging and transfer system, comprising:
a plurality of transfer members in a stacked arrangement, each transfer member including:
a lower transfer member surface spaced apart from an upper transfer member surface;
a plurality of side transfer member surfaces positioned proximate to the upper transfer member surface;
a plurality of transfer apertures disposed in a pattern in the upper transfer member surface and extending through the lower transfer member surface, each transfer aperture configured to receive a pipette tip;
at least one engagement ridge positioned proximate the upper transfer member surface on of each of the plurality of side transfer member surfaces;
a first gripping element positioned on a first side transfer member surface proximate the upper transfer member surface and a second gripping element positioned proximate the upper transfer member surface on a second side transfer member surface, the first gripping element and second gripping element each configured to effect an insertion and a removal of the transfer member from a storage container; and
a plurality of locking projections disposed upon the upper transfer member surface;
a packaging container configured to receive each of the plurality of transfer members, the packaging container including:
a lower packaging unit that includes:
a bottom lower packaging surface;
a first plurality of side lower packaging surfaces proximate and substantially perpendicular to the bottom packaging surface, each of the first plurality of side lower packaging surfaces including a cut-out portion configured to allow each transfer member to be grasped through the cut-out portion;
a second plurality of side lower packaging surfaces positioned laterally opposite the first plurality of side lower packaging surfaces and having the bottom lower packaging surface disposed therebetween, each of the second plurality of side lower packaging surfaces proximate and substantially perpendicular to the bottom packaging surface;
an upper packaging unit configured to slidably cover the lower packaging unit, including:
a top upper packaging surface, and
a first plurality of side upper packaging surfaces proximate and substantially perpendicular to the top upper packaging surface, and
a second plurality of side upper packaging surfaces positioned laterally opposite the first plurality of side upper packaging surfaces and having the top upper packaging surface disposed therebetween, each of the second plurality of side upper packaging surfaces proximate and substantially perpendicular to the top upper packaging surface.

20. The packaging container of claim 19, further comprising:
a packaging support member configured to receive and support a lower-most transfer member positioned within the lower packaging unit; and
a stabilizing plate including a plurality of projections configured in the pattern of the plurality of transfer apertures of the transfer member, the plurality of projections inserted at least partially in a first end of a pipette tips disposed within an upper-most transfer member positioned within the lower packaging unit.
